(19) United States
(12) Patent Application Publication
(10) Pub. No.: US 2024/0327961 A1
(43) Pub. Date: Oct. 3, 2024

(54) HIGH STRENGTH COLD ROLLED STEEL STRIP SHEET FOR AUTOMOTIVE USE HAVING GOOD WITHSTANDABILITY TO RETAINED AUSTENTITE DECOMPOSITION

(71) Applicant: VOESTALPINE STAHL GMBH, Linz (AT)

(72) Inventors: Katharina STEINEDER, Linz (AT); Thomas HEBESBERGER, Pasching (AT); Reinhold SCHNEIDER, Wels (AT)

(21) Appl. No.: 18/580,604

(22) PCT Filed: Jul. 20, 2022
(86) PCT No.: PCT/EP2022/070238

§ 371 Date: Jan. 18, 2024

(30) Foreign Application Priority Data
Jul. 20, 2021 (SE) 2150962-5

(51) Int. Cl. C22C 38/02; C21D 8/02; C21D 9/46; C22C 38/00; C22C 38/04; C22C 38/06; C22C 38/22; C22C 38/24; C22C 38/26; C22C 38/28; C22C 38/32

(52) U.S. Cl. CPC C22C 38/02; C21D 8/0205; C21D 8/0226; C21D 8/0236; C21D 8/0242; C21D 8/0273; C21D 8/0278; C21D 9/46; C22C 38/002; C22C 38/04; C22C 38/06; C22C 38/22; C22C 38/24; C22C 38/26; C22C 38/28; C22C 38/32; C21D 2211/001; C21D 2211/005; C21D 2211/008

(57) ABSTRACT

A high strength cold rolled steel strip or sheet has a steel composition comprising (in wt. %) 0.15-0.25 C, 0.3-0.5 Si, 2.0-3.0 Mn, 0.5-1.0 Al, 0.005-0.5 Cr, a thermal stability θ>0, where θ=68−500×C+4×Mn+60×Al−22×Si, the content of C, Mn, Si, Al in weight %, and a mechanical stability (kₚ) 5-35, mechanical properties fulfilling the following condition: tensile strength (Rₘ)≥980 MPa, and optionally at least one of the following conditions: yield strength (R_{p0.2})≥400 MPa, yield ratio (R_{p0.2}/Rₘ)≤0.65, Total Elongation (A₂₅)≥10%; and a microstructure comprising: Retained austenite (RA)≥8%. A method manufacturing the steel strip or sheet and an automotive structural part comprising the steel sheet also are provided.

### CROSS-REFERENCE TO RELATED APPLICATION(S)

This is a National Stage Entry into the United States Patent and Trademark Office from International Patent Application No. PCT/EP2022/070238, filed on Jul. 20, 2022, which relies on and claims priority to Swedish Patent Application No. 2150962-5, filed on Jul. 20, 2021, the entire contents of both of which are incorporated herein by reference.

### FIELD OF THE INVENTION

The present invention relates to high strength steel strip or sheets suitable for applications in automobiles. In particular, the invention relates to cold rolled steel strip or sheets having a tensile strength of at least 980 MPa and good withstandability to retained austenite decomposition.

### BACKGROUND OF THE INVENTION

For a great variety of applications increased strength levels are a pre-requisite for light-weight constructions in particular in the automotive industry, since car body mass reduction results in reduced fuel consumption.

Automotive body parts are often stamped out of sheet steels, forming complex structural members of thin sheet. However, such parts cannot be produced from conventional high strength steels, because of a too low formability for complex structural parts. For this reason, multiphase Transformation Induced Plasticity aided steels (TRIP steels) have gained considerable interest in the last years, in particular for use in auto body structural parts.

TRIP steels possess a multi-phase microstructure, which includes a meta-stable retained austenite phase, which is capable of producing the TRIP effect. When the steel is deformed, the austenite transforms into martensite, which results in remarkable work hardening. This hardening effect acts to resist necking in the material and postpone failure in sheet forming operations. The microstructure of a TRIP steel can greatly alter its mechanical properties.

A problem is that the retained austenite can decompose when partitioning the steel at 350-450° C. after final annealing. To mitigate this problem alloying with Si, Al, and P has been suggested to suppress the cementite precipitation and thereby stabilizing the austenite.

However, steels may be subjected to even higher temperatures (>450° C.) after the partitioning. For instance, when hot dip galvanizing, galvannealing, or welding parts together during manufacturing of e.g. an automotive.

There is therefore a need to provide a steel that has better withstandability to retained austenite decomposition at elevated temperatures (>450° C.).

### SUMMARY OF THE INVENTION

The present invention is directed to high strength (TRIP) steel strip or sheets having a tensile strength of above 980 MPa. The steel of the invention is therefore designed to have a good withstandability to retained austenite decomposition at elevated temperatures (>450° C.). The invention aims at providing a steel composition that can be processed to structural parts in the automotive industry especially involving deep drawing operations such as front and center pillar, vehicle door frame reinforcements. It should further be possible to produce the steel strip or sheets on an industrial scale in a Continuous Annealing Line (CAL) or a Hot Dip Galvanizing Line (HDG) or Galvannealing Line.

### BRIEF DESCRIPTION OF THE DRAWINGS

FIG. 1 shows a typical heat cycle for an optional continuous annealing line (CAL) before a final Continuous Annealing Line (CAL), a Hot Dip Galvanizing Line (HDG), or a Galvannealing Line.

FIG. 2 shows a typical heat cycle of a final Continuous Annealing Line (CAL).

FIG. 3 shows a typical heat cycle of a Hot Dip Galvanizing Line (HDG).

FIG. 4 shows a typical heat cycle of a Galvannealing Line.

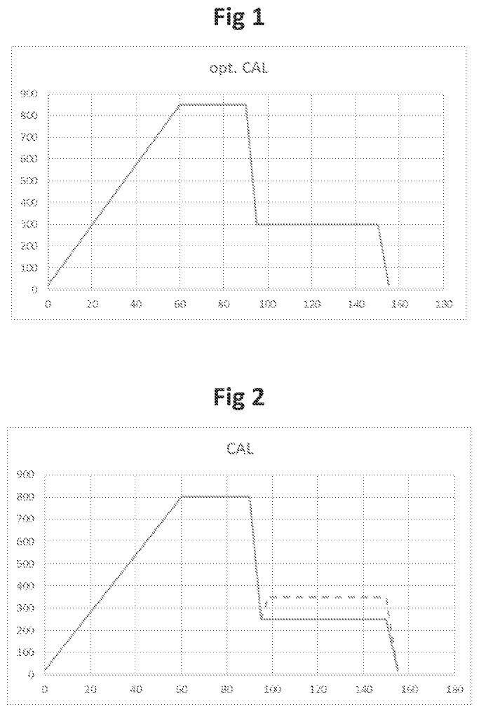

### DETAILED DESCRIPTION OF EMBODIMENT(S) OF THE INVENTION

The invention is described hereinbelow.

In a preferred embodiment the cold rolled steel strip or sheet has a composition consisting of the following alloying elements (in wt. %):
C 0.15-0.25
Si 0.3-0.5
Mn 2.0-3.0
Al 0.5-1.0
Cr 0.005-0.5
Nb ≤0.1
Ti ≤0.1
N ≤0.05
Mo ≤0.5
B ≤0.01
V ≤0.2
P ≤0.05
Ca ≤0.05
Cu ≤0.1
Ni ≤0.2
O ≤0.0003
H ≤0.0020
   the balance consists of iron and impurities.

The importance of the separate elements and their interaction with each other as well as the limitations of the chemical composition of the claimed alloy are briefly explained in the following. All percentages for the chemical composition of the steel are given in weight % (wt. %) throughout the description. The amount of hard phases is given in volume % (vol. %). Upper and lower limits of the individual elements can be freely combined within the limits set out in the claims. The arithmetic precision of the numerical values can be increased by one or two digits for all values given in the present application. Hence, a value of given as e.g. 0.1% can also be expressed as 0.10 or 0.100%.

### C: 0.15-0.25%

C stabilizes the austenite and is important for obtaining sufficient carbon within the retained austenite phase. C is also important for obtaining the desired strength level. Generally, an increase of the tensile strength in the order of 100 MPa per 0.1% C can be expected. When C is lower than 0.15% then it is difficult to attain a tensile strength of 980 MPa. If C exceeds 0.25%, then the weldability is impaired. The upper limit may thus be 0.25, 0.24, 0.23, 0.22, 0.21 or 0.20%. The lower limit may be 0.15, 0.16 or 0.17%. A preferred range is 0.15-0.25%.

### Si: 0.3-0.5%

Si acts as a solid solution strengthening element and is important for securing the strength of the thin steel sheet. Si suppresses the cementite precipitation and has been used for austenite stabilization. However, if the content is too high, then too much silicon oxides will form on the strip surface, which may lead to cladding on the rolls in the CAL or HDG and surface defects on subsequently produced steel sheets. After cold rolling these oxides may also result in undesired galvanizing problems. Furthermore, too high Si content may lower RA-stability at elevated temperatures (>450° C.) at the later stages of the manufacturing process, such as Hot-dip galvanizing and galvannealing, or at post production operations such as welding. Furthermore, a Si-content>0.5% can cause liquid metal embrittlement (LME) during welding. The upper limit is therefore 0.5% and may be restricted to 0.49, 0.48, or 0.47%. The lower limit is 0.3% and may be restricted to 0.31, 0.32, 0.33, 0, 34, or 0.35. A preferred range is 0.3-0.5%.

### Mn: 2.0-3.0%

Manganese is a solid solution strengthening element, which stabilises the austenite by lowering the Mₛ temperature and prevents ferrite and pearlite to be formed during cooling. In addition, Mn lowers the A_{c3} temperature and is important for the austenite stability, particularly at elevated temperatures (>450° C.). At a content of less than 2.0% it might be difficult to obtain the desired amount of retained austenite, a tensile strength of 980 MPa and the austenitizing temperature might be too high for conventional industrial annealing lines. In addition, at lower contents it may be difficult to avoid the formation of polygonal ferrite. However, if the amount of Mn is higher than 5.0%, problems with segregation may occur because Mn accumulates in the liquid phase and causes banding resulting in a potentially deteriorated workability. The upper limit may therefore be 3.0, 2.9, 2.8, 2.7, 2.6 or 2.5%. The lower limit may be 2.0, 2.1, 2.2 or 2.3%. A preferred range is 2.0-3.0%.

### Al: 0.5-1.0%

Al promotes ferrite formation and is also commonly used as a deoxidizer. Al suppresses the cementite precipitation and is used for austenite stabilization. Al has been found out to be beneficial for RA stability at elevated temperatures (>450° C.). Al addition does not affect coatability negatively. A drawback with higher Al, is that the Mₛ temperature and A_{c3} temperature is increased with an increasing Al content. The upper limit is therefore 1.0% and may be restricted to 0.9, 0.8 or 0.75%. The lower limit is 0.5% and may further by restricted to 0.6 or 0.7%. A preferred range is 0.5-1.0%.

### Cr: 0.005-0.5%

Cr is effective in increasing the strength of the steel sheet. Cr is an element that forms ferrite and retards the formation of pearlite and bainite. The A_{c3} temperature and the Mₛ temperature are only slightly lowered with increasing Cr content. Cr results in an increased amount of stabilized retained austenite. The amount of Cr is limited to 0.5%. The upper limit may be restricted to 0.45, 0.40, 0.35, 0.30 or 0.25%. The lower limit is 0.005 and may further be restricted to be 0.01, 0.05, 0.1, 0.11, 0.12, 0.13, 0.14, or 0.15%.

### Nb: ≤0.1%

Nb is commonly used in low alloyed steels for improving strength and toughness, because of its influence on the grain size. Nb increases the strength elongation balance by refining the matrix microstructure and the retained austenite phase due to precipitation of NbC. The steel may contain Nb in an amount of ≤0.1%. A deliberate addition of Nb is not necessary according to the present invention. The upper limit may therefore be restricted to ≤0.03%. The upper limit may further be restricted to 0.01, or 0.004%.

### Mo≤0.5%

Molybdenum can be added to improve strength. It may further enhance the benefits of NbC precipitates by reducing the carbide coarsening kinetics. The steel may contain Mo in an amount of ≤0.5%. The upper limit may be restricted to 0.4, 0.3, 0.2, 0.1, or 0.05%. A deliberate addition of Mo is not necessary according to the present invention. The upper limit may therefore be further restricted to 0.03, 0.02, or 0.01%

### V: ≤0.2%

The function of V is similar to that of Nb in that it contributes to precipitation hardening and grain refinement. The steel may contain V in an amount of ≤0.2%. The upper limit may be restricted to 0.15, 0.10, 0.05, 0.03, or 0.01%. A deliberate addition of V is not necessary according to the present invention. The upper limit may therefore be restricted to ≤0.01%.

### Ti: ≤0.1%

Ti is commonly used in low alloyed steels for improving strength and toughness, because of its influence on the grain size by forming carbides, nitrides or carbonitrides. In particular, Ti is a strong nitride former and can be used to bind the nitrogen in the steel. However, the effect tends to be saturated above 0.1%. The upper limit may be restricted to 0.09, 0.07, 0.05, 0.03, or 0.01%. A deliberate addition of Ti is not necessary according to the present invention. The upper limit may therefore be restricted to ≤0.005%.

### Ca≤0.05

Ca may be used for the modification of the non-metallic inclusions. The upper limit is 0.05% and may be set to 0.04, 0.03, 0.01%. A deliberate addition of Ca is not necessary according to the present invention. The upper limit may therefore be restricted to ≤0.004%.

### Cu: ≤0.1%

Cu is an undesired impurity element that is restricted to ≤0.1% by careful selection of the scrap used. The upper limit may be restricted to ≤0.06%.

### Ni: ≤0.2%

Ni is an undesired impurity element that is restricted to ≤0.2% by careful selection of the scrap used. The upper limit may be restricted to ≤0.08%.

### B: ≤0.01%

B increases hardness but may come at a cost of reduced bendability and is therefore not desirable in the present suggested steel. B may further make scrap recycling more difficult, and an addition of B may also deteriorate workability. A deliberate addition of B is therefore not desired according to the present invention. The upper limit may therefore be restricted to ≤0.0006%.

Other impurity elements may be comprised in the steel in normal occurring amounts.

It is also preferred to control the nitrogen content such that N: ≤0.05%, preferably ≤0.01%. A preferred range is 0.001-0.008%. In this range a stable fixation of the nitrogen can be achieved.

Oxygen and hydrogen can further be limited to
O: ≤0.0003
H: ≤0.0020

The θ-factor is an indication of thermal stability of the steel and the composition should fulfil the following condition:

θ>0,

where θ=68−500×% C+4×% Mn+60×% Al−22×% Si.

A negative θ-factor is bad for withstandability to retained austenite decomposition.

The lower limit of θ may be 5, 10, 15, 20, or 25.

The microstructural constituents are in the following expressed in volume % (vol. %).

The steel comprises a matrix of tempered martensite (TM) and/or bainitic ferrite (BF). The total amount is of TM+BF≥50% with retained austenite inclusions embedded in the matrix. The upper limit of TM+BF may be 90%. Polygonal ferrite and fresh martensite may also be present in the matrix. Retained austenite (RA) is a prerequisite for obtaining the desired TRIP effect. The amount of retained austenite is important for the invention and should be ≥8%, preferably 10-20%. The upper limit may be 20, 19, 18, 17, 16, or 15%. The retained austenite is preferably predominantly needle shaped. The amount of retained austenite as measured by means of the saturation magnetization method described in detail in Proc. Int. Conf. on TRIP-aided high strength ferrous alloys (2002), Ghent, Belgium, p. 61-64.

Polygonal ferrite (PF) may be in the range of 0-40%. The upper limit may be 30, 20, 10, 5 or 1%. The steel can be free of polygonal ferrite (PF).

Fresh martensite (FM) may be in the range of 0-10%. The upper limit may be 7, 5, 3, or 1%. The steel can be free of fresh martensite (FM).

The ratios of the microstructure can be obtained by cutting out a sample from a steel plate and polishing a cross section of a plate perpendicular to the rolling direction. The sample was grinded to ¼ of the thickness of the plate for the measurements. The surface was etched to make the phases easier to identify. A scanning electron microscope (SEM) using 2000 times magnification can be used.

The mechanical properties of the claimed steel are important and at least one of the following requirements should be fulfilled:

$$\begin{matrix}yield strength ( {R}_{p 0.2} ) & \geq 400 M Pa , preferably 400 - 700 MPa . \\ Tensile strength ( {R}_{m} ) & \geq 980 MPa , preferably 980 - 1300 MPa . \\ Total elongation ( {A}_{25} ) & \geq 10 \% , preferably > 12 \% \\ yield ratio ( {R}_{p 0.2} / {R}_{m} ) & \leq 0.65\end{matrix}$$

Preferably, all these requirements are fulfilled at the same time.

The upper limit of the tensile strength (Rₘ) can further be limited to 1260, 1240, 1220, 1200, 1180, 1160, 1140, 1120, or 1100 MPa.

The upper limit of the yield strength (R_{p0.2}) can further be limited to 680, 660, 640, 620, 600, 580, 560, 540, or 520 MPa. A preferred interval is 400-600 MPa.

A lower yield ratio makes it easier to cold form the material and the yield ratio is therefore at most 0.65. The upper limit of the yield ratio (R_{p0.2}/Rₘ) can further be limited to 0.62, 0.60, 0.58, 0.56, 0.54, 0.52, or 0.50. The lower limit could be 0.30, 0.32, 0.34, 0.36, 0.38, or 0.40.

The Rₘ, R_{p0.2} values as well as the total elongation (A₂₅) are derived in accordance with the Industrial Standard ISO 6892-1, wherein the samples are taken in the longitudinal direction of the strip.

Mechanical stability (kₚ) is a parameter that describes the mechanical stability of the retained austenite (RA). Factors influencing the kp value includes the chemical composition of the austenite mainly via carbon enrichment, the grain size—smaller grain size leads so more stable RA, the morphology of the RA—globular RA is less stable than lath or needle shaped RA. For these reasons, the chemical composition of the steel as well as the heat treatment parameters are decisive.

The steel should have a mechanical stability (kₚ) in the range of 5-35, preferably 10-35. A kₚ-value above 35 indicates low stability of retained austenite (RA) against mechanical loading, If the kₚ-value is too high RA already transforms during elastic loading (stress-assisted) or at very low plastic strains and therefore does not sufficiently increase the work hardening behaviour of a steel and enables high elongations. The invention aims for an optimal stability. A kₚ-value in the suggested range improves the stability of RA against mechanical loading and is beneficial for withstandability to retained austenite decomposition. Particularly the steel should have a kₚ value of 3-35 and a positive θ-factor (θ>0) for an improved stability of the retained austenite.

The mechanical stability (kφ is determined by interrupted tensile testing. Tensile samples are deformed to a certain strain that lies between yielding and before necking of the specimen. Subsequently the retained austenite content in the undeformed and deformed state is determined.

Following relation given by Ludwigson and Berger in J. Iron Steel Inst. 1969, vol. 207, pp. 63 is applied:

$$\frac{{V}_{γ0} - {V}_{γ}}{{V}_{γ}} = {k}_{p} \times {ε}^{p}$$

V_{γ0} . . . initial retained austenite content
V_{γ} . . . retained austenite content after deformation
ε . . . true strain
p . . . constant related to autocatalytic effect
kₚ . . . indication for retained austenite stability

Matsumura et al. suggested in Scr. Metall. 1987, vol. 21, pp. 1301 that in TRIP aided steels p can be assumed to be 1. Therefore, the kₚ-value can be derived from the combined interrupted tensile testing and retained austenite measurements. True strain is the natural logarithm of the ratio of the instantaneous gauge length to the original gauge length in a tensile test. The retained austenite content can be determined by saturation magnetization measurement. The initial retained austenite content (V_{γ0}) can be measured in the final heat treated product. The sample for the retained austenite after deformation (V_{γ}) should be taken out of the gauge length of the deformed tensile specimen.

The mechanical properties of the steel strip or sheets of the present invention can be largely adjusted by the alloying composition and the microstructure. The microstructure can be adjusted by the heat treatment in the CAL, in particular by the isothermal treatment temperature in the partitioning step.

The suggested steel can be produced by the steps:
a) making steel slabs of the conventional metallurgy by converter melting and secondary metallurgy with the composition suggested above.
b) The slabs are hot rolled in austenitic range to a hot rolled strip. Preferably by reheating the slab to a temperature between 1000° C. and 1280° C., rolling the slab completely in the austenitic range wherein the hot rolling finishing temperature is greater than or equal to 850° C. to obtain the hot rolled steel strip.
c) Thereafter the hot rolled strip is coiled at a coiling temperature in the range of 400-580° C.
d) The coiled strip is thereafter batch annealed at a temperature in the range of 500-650° C., preferably 550-650° C., for a duration of 5-30 h.
e) Optionally subjecting the coiled strip before or after the batch annealing to a scale removal process, such as pickling.
f) Thereafter cold rolling the annealed steel strip with a reduction rate of 50% or more, preferably around 50-70% reduction. The thickness of the cold rolled strip is preferably in the range of 0.9-2.0 mm.

The cold rolled strip is thereafter subjected to a single or double annealing process.

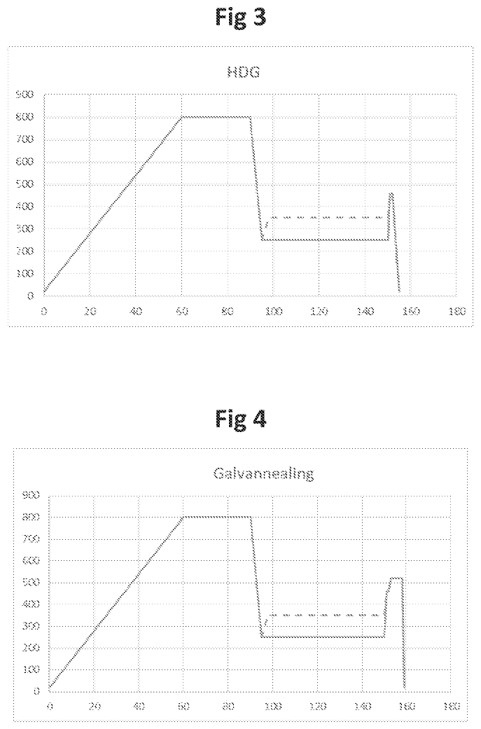

In the single annealing process, the cold rolled strip is conveyed to a final Continuously Annealing Line (CAL) or a Hot Dip Galvanizing Line (HDG). FIG. 2 shows the heat cycle of the final Continuous Annealing Line (CAL), FIG. 3 shows the heat cycle of the Hot dip Galvanizing line (HDG), and FIG. 4 shows the heat cycle of the Galvannealing line.

The CAL process includes the steps:
k) heating the strip to an annealing temperature TA higher than A_{c1}+(A_{c3}−A_{c1})/3 but less than 1000° C. and annealing the strip at a dew point in the range of −40° C. to +10° C. for a time of more than 30 s;
l) quenching the strip by cooling it down to a quenching temperature QT between 200° C. and 400° C. The quenching rate may be in the range of 20-60° C./s;
m) heating the strip up to a partitioning temperature PT between 250° C. and 450° C. and maintaining the strip at this temperature for a partitioning time Pt between 10 s and 200 s, this step being a partitioning step;
n) cooling the strip down to the room temperature. The cooling rate may be in the range of 5-60° C./s; and
o) optionally making sheets from the strips.

Optionally step p) subjecting the strip or sheet to zinc electroplating or to Physical Vapor Deposition (PVD).

In step k) the annealing temperature TA is preferably less than 950° C., more preferably less than 900° C.

In step m) the partitioning temperature PT may further be limited to the range 350-450° C.

In step m) the partitioning temperature PT may optionally be the same as quenching temperature QT, when the quenching temperature QT is in the range of 350-400° C.

In step l) and/or step n) the strip may be gas quenched. The cooling rate in step n) may further be restricted to 20-60° C./s.

The Hot DIP Galvanizing Line (HDG) is processed the same way as the final CAL process, but includes hot dip coating at the end of the partitioning (step m). The strip is immersed in molten zinc (mainly zinc) around 460° C. During hot dip coating the temperature will hence come above 450° C. The Hot Dip Galvanizing Line (HDG) can be the same line as the CAL with added hot dip coating.

The Galvannealing line is the same as the Hot Dip Galvanizing Line (HDG) with the addition of an annealing step following the hot dip coating. I.e. processed the same way as the CAL process, but including galvannealing at the end of the partitioning (step m). Galvannealing is a combination of galvanizing and annealing around 480-560° C. in order to facilitate a higher degree of Fe in the ZnFe coating. The annealing step after the HDG step is exaggerated in the FIG. 4 to make it more visible—in reality the duration would be in the range of seconds.

In the double annealing process, the cold rolled strip is first conveyed to a Continuously Annealing Line (CAL) comprising the steps of:
g) heating the strip to an annealing temperature TA higher than A_{c1}+(A_{c3}−A_{c1})/1.5 but less than 950° C. and annealing the strip at a dew point of −40° C. to +10° C. for a time of more than 30 s;
h) quenching to QT<350° C. The quenching rate may be in the range of 20-60° C./s;
i) maintain the QT for at least 10 s; and
j) cooling the strip down to the room temperature. The cooling rate may be in the range of 5-60° C./s.

In step g) and/or step j) the strip may be gas quenched. The cooling rate in step j) may further be restricted to 20-60° C./s.

The strip is thereafter subjected to the same process as described for the single annealing, i.e. running through the final Continuous Annealing Line (CAL) again (or a second CAL line following a first) or through the Hot DIP Galvanizing Line (HDG) or through a Galvannealing Line.

### Examples

Inventive steels I1-I3, and reference steels R1-R2 were produced by conventional metallurgy by converter melting and secondary metallurgy. The compositions are shown in table 1, further elements apart from Fe, were present only as impurities, and below the lowest levels specified in the present description. Steel I1-I3 and R1 were all within the composition ranges of the preferred embodiment, whereas steel R2 had an Al content below the preferred range. The thermal stability (θ-factor) is positive for steels I1-I3, and R1, but negative for reference steel R2.

TABLE 1
Composition of the steel and θ-factor.

| Steel | C | Si | Mn | Cr | Al | θ-factor |
|---|---|---|---|---|---|---|
| I1 | 0.17 | 0.46 | 2.33 | 0.23 | 0.96 | 40 |
| I2 | 0.17 | 0.38 | 2.35 | 0.23 | 0.74 | 31 |
| I3 | 0.20 | 0.39 | 2.89 | 0.03 | 0.51 | 2 |
| R1 | 0.20 | 0.40 | 2.90 | 0.02 | 0.70 | 13 |
| R2 | 0.16 | 0.44 | 2.33 | 0.24 | 0.05 | −7 |

Slabs of the steel alloys were produced in a continuous caster. The slabs were reheated and subjected to hot rolling to a thickness of 2.8 mm. The hot rolling finishing temperature was about 900° C. and the coiling temperature was about 500° C. The hot rolled strips were pickled and batch annealed at 620° C. for a time of 15 hours in order to reduce the tensile strength of the hot rolled strip and thereby reducing the cold rolling forces. The strips were thereafter cold rolled in a five stand cold rolling mill to a final thickness of 1.4 mm.

The cold rolled strips were then then annealed in a continuous annealing line (CAL). The annealing cycle comprised of heating to an annealing temperature (Table 3) and fully austenitizing for 150 s. The annealed strips were thereafter rapidly cooled with cooling rate of 50° C./s to a quenching temperature (Table 3). After quenching the temperature was raised at a heating rate of 20° C./s to a partitioning temperature (Table 3) and held there at a partitioning time (Table 3), before quenching to room temperature at 50° C./s.

TABLE 3
Parameters of the treatment in the CAL.

| | Annealing | Quenching | Partitioning | Partitioning |
|---|---|---|---|---|
| Steel | temp. (° C.) | temp. (° C.) | temp (° C.) | time (s) |
| I1 | 850 | 380 | 420 | 40 |
| I2 | 830 | 380 | 420 | 40 |
| I3 | 810 | 370 | 420 | 40 |
| R1 | 950 | 300 | 400 | 20 |
| R2 | 830 | 380 | 400 | 40 |

The steel produced according to the invention was found to have excellent mechanical properties as shown in Table 4, whereas the reference steels R1 and R2 were inferior.

TABLE 4
Mechanical properties and retained austenite levels.

| | YS | TS | YR | TE | | | RA |
|---|---|---|---|---|---|---|---|
| | R_{p0.2} | Rₘ | (R_{p0.2}/ | A₂₅ | | | after |
| Steel | (MPa) | (MPa) | Rₘ) | (%) | kₚ | RA | 560° C. |
| I1 | 456 | 1031 | 0.44 | 17 | 33 | 12 | 13 |
| I2 | 441 | 1009 | 0.44 | 19 | 16 | 14 | 12 |
| I3 | 490 | 991 | 0.49 | 16 | 15 | 10 | 8 |
| R1 | 960 | 1550 | 0.62 | 2 | 98 | 13 | 5 |
| R2 | 725 | 988 | 0.73 | 13 | 21 | 10 | 6 |

All steels had a yield strength above 400 MPa, a tensile strength above 980 MPa. The yield ratio was below 0.65 for steel I1-I3 and R1 making them easy to cold form. Reference steel R2 did not meet the yield ratio requirements. Total elongation (A₂₅) was more than 10% for the inventive steels and reference steel R2, but only 2% for the reference steel R1.

The inventive steels and reference steel R2 had a mechanical stability (kₚ) within the range 5-35, whereas the reference steel R1 had a mechanical stability (kₚ) of 98, outside the desired range.

The microstructure comprised more than 8% retained austenite (RA) for all steels. To test the stability of the retained austenite, steel samples were heated to 560° C. at a heating rate of 20° C./s. As can be seen the inventive steels lost at most 20% retained austenite (steel I3) and maintained retained austenite amounts above 8%. Hence, the inventive steels showed good withstandability to retained austenite decomposition.

The reference steels R1 and R2 lost about 60% respectively 40% retained austenite and both came well below the desired minimum amount of 8%. Thus, the steel (R1) with the mechanical stability (kₚ) outside the desired range performed worse than the inventive steels (I1-I3) in terms of stability of the retained austenite, and the reference steel R2 having a negative θ-factor also fell short in stability of the retained austenite.

The YS, TS, YR, TE, kₚ, RA values were all derived according to the method or standards disclosed above.

The material of the present invention can be widely applied to structural parts in the automotive industry especially involving deep drawing operations such as front and center pillar, vehicle door frame reinforcements.

1. A high strength cold rolled steel strip or sheet having:
a) a composition consisting of the following elements (in wt. %):
C 0.15-0.25
Si 0.3-0.5
Mn 2.0-3.0
Al 0.5-1.0
Cr 0.005-0.5
Nb ≤0.1
Ti ≤0.1
N ≤0.05
Mo ≤0.5
B ≤0.01
V ≤0.2
P ≤0.05
Ca ≤0.05
Cu ≤0.1
Ni ≤0.2
O ≤0.0003
H ≤0.0020
the balance being iron and impurities;
b) a thermal stability θ>0,
where θ=68−500×C+4×Mn+60×Al−22×Si,
the content of C, Mn, Si, Al in weight %:
a mechanical stability (kₚ) 5-35;
c) mechanical properties fulfilling the following condition:
tensile strength (Rₘ)≥980 MPa
and optionally at least one of the following conditions:
yield strength (R_{p0.2})≥400 MPa
yield ratio (R_{p0.2}/Rₘ)≤0.65
Total Elongation (A₂₅)≥10%; and
d) a microstructure comprising:
Retained austenite (RA)≥8%.

2. The high strength cold rolled steel strip or sheet according to claim 1, wherein the microstructure fulfils at least one of the following requitements (in vol. %);
retained austenite 10-20
fresh martensite 0-10
bainitic ferrite and tempered martensite 50-90, and
polygonal ferrite 0-40.

3. The high strength cold rolled steel strip or sheet according to claim 2, wherein the microstructure comprises:
retained austenite 10-20
bainitic ferrite and tempered martensite 50-90
fresh martensite ≤5, and
polygonal ferrite ≤5.

4. The high strength cold rolled steel strip or sheet according to claim 1, wherein the yield ratio is less than 0.55.

5. The high strength cold rolled steel strip or sheet according to claim 1, wherein Nb≤0.01.

6. The high strength cold rolled steel strip or sheet according to claim 1, wherein Cr≥0.1.

7. A method of manufacturing of a cold rolled steel strip or sheet according to claim 1, comprising the following steps:
a) providing a steel slab;
b) hot rolling the slab in the austenitic range, wherein the hot rolling finishing temperature is greater than or equal to 850° C., to obtain the hot rolled steel strip;
c) coiling the hot rolled strip at a coiling temperature in the range of 400-580° C.;
d) batch annealing at a temperature in the range of 500-650° C. for a duration of 5-30 h;
e) optionally subjecting the coiled strip, before or after the batch annealing, to a scale removal process;
f) cold rolling the annealed steel strip with a reduction rate of 50% or more; and optionally one of step g)-step j);
g) heating the strip to an annealing temperature TA higher than A_{c1}+(A_{c3}−A_{c1})/1.5 but less than 950° C. and annealing the strip at a dew point of in the range of −40° C. to +10° C. for a time of more than 30 s;
h) quenching the strip to quenching temperature QT<350° C.;
i) maintaining the quenching temperature QT for at least 10 s;
j) cooling the strip down to the room temperature;
k) heating the strip to an annealing temperature TA higher than A_{c1}+(A_{c3}−A_{c1})/3 but less than 1000° C. and annealing the strip at a dew point of −40° C. to +10° C. for a time of more than 30 s;
l) quenching the strip by cooling it down to a quenching temperature QT between 200° C. and 400° C.;
m) heating the strip up to a partitioning temperature PT between 250° C. and 450° C. and maintaining the strip at this temperature for a partitioning time Pt between 10 s and 200 s, this step being a partitioning step;
n) cooling the strip down to the room temperature, and
o) optionally making sheets from the strips.

8. The method according to claim 7, wherein step m) includes at least one of hot dip coating or galvannealing at the end of the partitioning.

9. The method according to claim 7, wherein the quenching temperature QT is in the range of 350-400° C., and the partitioning temperature PT in step m) is the same as quenching temperature QT of step l).

10. The method according to claim 7, wherein the annealing temperature TA in step k) is less than 950° C., preferably less than 900° C.

11. An automotive structural part comprising the high strength cold rolled steel material according to claim 1.

12. The automotive structural part according to claim 11, wherein the structural part is at least one of a front pillar, a center pillar, or a vehicle door frame reinforcement of an automobile.

13. The high strength cold rolled steel strip or sheet according to claim 1, wherein the Total Elongation (A₂₅)>12%.

14. The high strength cold rolled steel strip or sheet according to claim 1, wherein the microstructure fulfils all the requirements (in vol. %):
retained austenite 10-20
fresh martensite 0-10
bainitic ferrite and tempered martensite 50-90, and
polygonal ferrite 0-40.

15. The method of manufacturing of a cold rolled steel strip or sheet according to claim 7, wherein a scale removal process comprises pickling.
